(19) United States
(12) Patent Application Publication
(10) Pub. No.: US 2013/0139067 A1
(43) Pub. Date: May 30, 2013

(54) Changing Identities in a Social Networking System

(71) Applicants: Jeffrey Andrew Kanter, (US); Eric Faller, (US); Peter Xiu-Deng, (US); Nicholas Hage Schrock, (US); Olaoluwa Okelola, (US)

(72) Inventors: Jeffrey Andrew Kanter, (US); Eric Faller, (US); Peter Xiu-Deng, (US); Nicholas Hage Schrock, (US); Olaoluwa Okelola, (US)

(21) Appl. No.: 13/307,500

(22) Filed: Nov. 30, 2011

(51) Int. Cl. G06F 3/01; G06F 15/16

(52) U.S. Cl. 715/747

(57) ABSTRACT

A user of a social networking system interacting in the system as the user, may request to undertake the identity of a non-user page of which the user is an administrator. If the user undertakes the identity of the page, the user interacts with the system as the page. Additionally, the social information displayed to the user is personalized for the page.

### BACKGROUND

Described embodiments relate generally to social networking systems, and in particular to changing the identity of a user in a social networking system.

Social networking systems provide an environment in which users can connect to and communicate with one another. Entities, such as businesses, organizations, and celebrities have used the popularity of social networking systems to broadcast information to users. One way of broadcasting information is by creating a page within a social networking system. Through the page an entity can make information available to those users who choose to connect with the page.

Typically an administrator manages the page for the entity. The administrator is a user of the system and as a result the user has his own social networks and social information.

### SUMMARY

Embodiments provide methods, systems, and computer readable storage media for changing the identity through which a user interacts with a social networking system. A user of the social networking system may interact with the system as the user. However, the user may request to undertake the identity of a non-user page of which the user is an administrator. If the user undertakes the identity of the page, the user interacts with the system as the page. Additionally, the social information displayed to the user is personalized for the page.

### BRIEF DESCRIPTION OF THE DRAWINGS

FIG. 1 is a diagram of a social networking environment according to one embodiment.

FIG. 2 is a flow diagram of a process for changing the identity of a user in a social networking system according to one embodiment.

FIG. 3 is an example of a news feed displayed to a user according to one embodiment.

FIG. 4 is an example of notifications of a user according to one embodiment.

FIG. 5 is an example of a posting by a user on a wall of another user according to one embodiment.

FIG. 6 is an example of a user selecting an option to interact in a social networking system as a page according to one embodiment.

FIG. 7 is an example of pages of which a user is an administrator according to one embodiment.

FIG. 8 is an example of a user selecting to have the identity of a page in a social networking system according to one embodiment.

FIG. 9 is an example of notifications of a page displayed to a user according to one embodiment.

FIG. 10 is an example of a news feed displayed to a user according to one embodiment.

FIG. 11 is an example of a user interacting in a social networking system as a page according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

The embodiments described herein provide systems, methods, and computer readable storage media for changing the identity of a user in a social networking system.

The social networking system provides a way for users to connect and communicate with other users. The social networking system allows users to establish relationships or connections with others and share information in a variety of useful ways. A user is a person who has signed up with the social networking system to use the resources of the system. In other words, a user is a person who has created an account with the social networking system.

The social networking system includes non-user pages. A non-user page is a page that represents an entity in the social networking system but is not registered as a user in the system (i.e., does not have a user account). A non-user page may be created for entities, such as a business, a location, a company, an organization, an institution, a product, a brand, a group, a public figure (i.e., a celebrity), a cause, and a community. A non-user page of an entity is used to broadcast information about the entity in an official manner to users who choose to connect with the page.

A non-user page has one or more administrators. An administrator is a user of the social networking system that manages the page. The administrator controls some or all of the configuration and the content of the page. Additionally, the administrator can interact with the social networking system as the page. For example, the administrator can post on other pages as the page.

Thus, a user that is an administrator of a page can change the identity used to interact with the social networking system. The user can switch between interacting with the social network as himself or as the page. Depending on the identity the user is using to interact with the network, different social information will be available to the user to access. For example, if the user is interacting with the social networking system as himself, the user's notifications will be displayed to the user. However, if the user is interacting as the page, the notifications of the page will be displayed to the user.

### Architecture

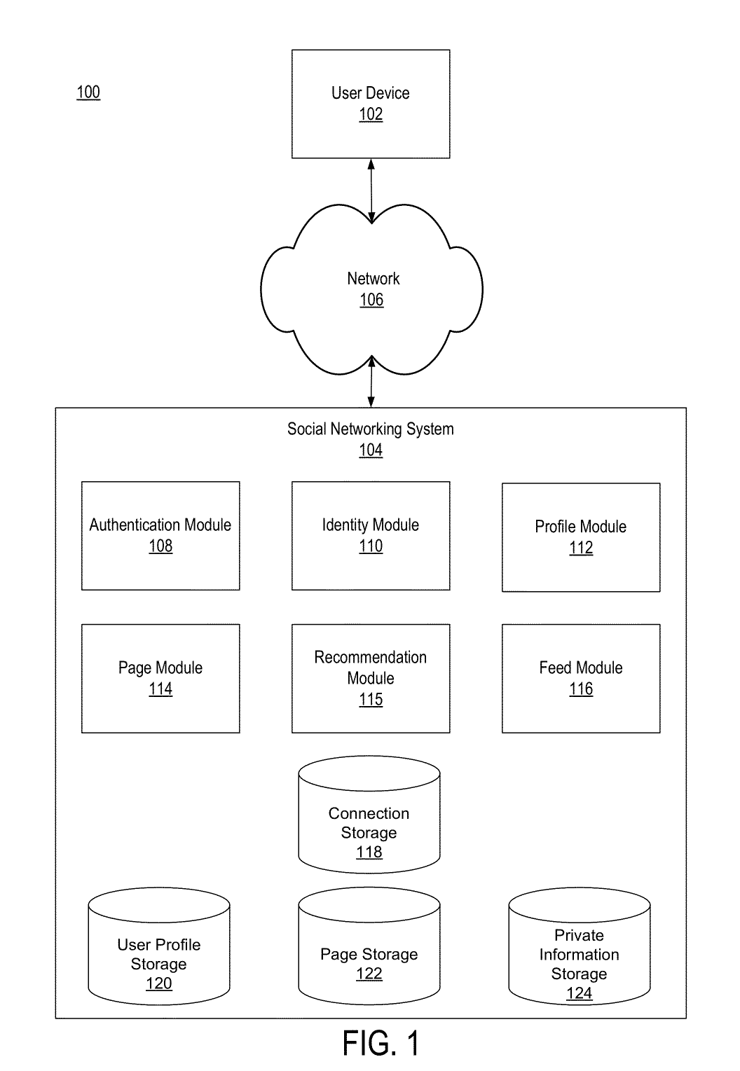

FIG. 1 is a diagram of a social networking environment 100 according to one embodiment. The environment 100 includes a user device 102 and the social networking system 104 connected by a network 106. For ease of understanding the embodiments described herein, FIG. 1 includes a single user device 102. However, the social networking environment 100 may include many more user devices 102 (e.g., millions of user devices 102).

The network 106 represents the communication pathway between the user device 102 and the social networking system 104. In one embodiment, the network 106 is the Internet and uses standard communications technologies and/or protocols. The network 106 can also utilize dedicated, custom, or private communications links that are not necessarily part of the Internet. The network 106 may comprise any combination of local area and/or wide area networks, using both wired and wireless communication systems.

The user device 102 comprises one or more computing devices that can receive inputs from a user and can transmit and receive data via the network 106. For example, a user device 102 may be a desktop computer, a laptop computer, a smart phone, a personal digital assistant (PDAs) or any other device including computing functionality and data communication capabilities. The user device 102 is configured to communicate with the social networking system 104 via the network 106.

The social networking system 104 comprises one or more computing devices that store one or more social networks. Each social network includes multiple users. According to various embodiments, the social networking system 104 may include a website, or alternatively a server that can be accessed through the network 106 by user device 102.

The social networking system 104 includes an authentication module 108, an identity module 110, a profile module 112, a page module 114, a recommendation module 115, a feed module 116, a connection storage 118, a user profile storage 120, a non-user page storage 122, and a private information storage 124. In other embodiments, the social networking system 104 may include additional, fewer, or different modules for various applications. Conventional components such as network interfaces, security mechanisms, failover servers, management and network operations consoles, and the like are not shown so as to not obscure the details of the system 104.

The connection storage 118 stores data describing connections between users and non-user pages in the social networking system 104. The connection storage 118 includes defined connections between users, between pages, and between users and pages. Users may select from predefined types of connections, or define their own connection types as needed. In one embodiment, when a user establishes a connection with another user, the users become friends in the system 104. In one embodiment, a user or page establishes a connection with another page by showing affinity towards the other page (e.g., by liking the other page).

The user profile storage 120 stores profiles of users of the social networking system 104. A user profile includes information about its respective user. In one embodiment, user profiles include biographic, demographic, and other types of descriptive information of their respective user, such as work experience, educational history, hobbies, preferences, interests, relationship information, location, and the like. A user profile may additionally include one or more of the following: postings by the user or other users on the profile, a listing of the user's friends, a listing of pages that the user is connected to, and a listing of activities that the user has engaged in through the social networking system 104 (e.g., shared links and videos). The postings may be, for example, multimedia cont (e.g., pictures and videos), messages, comments, status updates, locations, check-ins, liking an object, questions, events, links, and articles.

The non-user page storage 122 stores non-user pages of the social networking system 104. As described above, a non-user page is a page that represents an entity that does not have a user account with the social networking system 104. In one embodiment, a non-user page of an entity includes information about the entity. For example, if the entity is a company, the page may include information, such as when the company was founded, the company's headquarters, the company's mission statement, or other content selected by the page's administrators. The page additionally includes postings by administrators on behalf of the page, as well as postings by other pages or users connected to the page. The page may also include information about users and pages that have a connection with the page and information about users' interactions with the page. Information is stored with a non-user page indicating which users are administrators of the page.

The private information storage 124 stores private information for users and pages. Private information of a user is information that is unique to the user and is not shared with other users. Private information of a page is unique to the page and only shared with administrators of the page. Private information may include, for example, messages received from users or pages, notifications of relevant social interactions in the social networking system 104, events of the user or page, requests from users or pages to become friends, and a list of users and pages with whom a connection has been established.

The authentication module 108 authenticates users seeking to access content of the social networking system 104. In one embodiment, the authentication module 108 maintains authentication information for each user that has created an account with the system 104. In one embodiment, the authentication information includes a user identifier and a password. In one embodiment, the identifier is the user's email address.

In one embodiment, when a user attempts to communicate with the social networking system 104, if the user is not logged into the system 104, the authentication module 108 presents a login page to the user via the user device 102. In the login page, a user that has previously created an account with the system 104 can enter their respective authentication information. When the authentication information is entered, the authentication module 108 verifies that information is valid. If the information is valid, the user is logged into the social networking system 104. In one embodiment, a user can setup the user device 102 to automatically log them in.

If a person has not previously created an account with the system 104, the person can request in the login page to sign up and become a user of the system 104. If the person request to sign up, the authentication module 108 has the person go through a sign up process. In one embodiment, the sign up process includes the person providing authentication information that the person wishes to use to login, personal information, and information for his or her profile.

The identity module 110 allows a user to change identities in the social networking system 104. If a user is an administrator of one or more non-user pages, the user can select to interact with the system 104 using the identity of the user (i.e., himself) or the identity of a non-user page of which the user is the administrator. The identity module 110 tracks the current identity of the user with system 104.

The social networking information (hereafter “social information”) accessible to the user and displayed to the user depends on the identity undertaken by the user. In other words, the social information displayed to the user is personalized according to current identity of the user. Social information includes, for example, information of the social networking system 104, such as profile information, page information, connection information, private information, and social interactions. A social interaction is an action performed by a user in the system 104, such as a post or updating a profile.

In one embodiment, when the authentication module 108 authenticates a user and logs the user into the social networking system 104, the user accesses the social networking system 104 under the identity of the user. In one embodiment, the identity module 110 makes accessible to the user private information of the user stored in the private information storage 124. In one embodiment, the private information made accessible includes the user's friend requests, notifications, events, and messages.

If the user through the user device 102 requests to change identities with the system 104, the identity module 110 identifies pages in the non-user page storage 122 of which the user is an administrator. The identity module 110 displays to the user the pages of which the user is an administrator. If the user requests to undertake the identity of a page, the identity module 110 makes accessible to user the private information of the selected page in the private information storage 124. In one embodiment, the private information includes events of the page, notifications of the page, and information as to the users and pages that have established a connection with the page. Therefore, even though the user is logged into the system 104 as the user, the user is able to undertake the identity of a non-user page without having to provide additional authentication information.

In one embodiment, as long the user's identity in the social networking system 104 is of a non-user page, the user's own private information is not accessible to the user. The identity module 110 provides the user with the option to change back to the identity of the user.

The profile module 112 manages the creation, access, and update of user profiles. In one embodiment, when a person becomes a user by signing up with the system 104, the profile module 112 creates a profile for the user in the user profile storage 120. The profile module 112 populates the created profile with information provided by the user during the sign up process.

When a user requests access to a profile stored in the user profile storage 120, the profile module 112 determines the current identity of the user with the system 104 from the identity module 110. Based on the identity of the user, the profile module 112 determines the information of the profile accessible to the requesting user. In one embodiment, the profile information accessible to the requesting user depends on the connections between the identity of the requesting user and the user of the requested profile. The profile module 112 retrieves from the user profile storage 120 and transmits to the user device 102 of the requesting user, profile information determined by the module 112 to be accessible by the current identity of the requesting user. The transmitted profile information is displayed to the requesting user.

As an example, if the requesting user is currently interacting with the system 104 as a non-user page and the non-user page does not have a direct connection with the user of the profile, the profile module 112 may determine to display to the requesting user very limited information of the profile (e.g., a profile picture, gender, and education information). On the other hand, if the requesting user is interacting with the system 104 as himself and is a friend of the profile user, the profile module 112 may determine to display the full profile. Thus, the profile information displayed to the requesting user is personalized according the user's current identity in the system 104.

The profile module 112 updates the profiles stored in the user profile storage 120 based on social interactions in the system 104. When a user requests to update his profile with a post or information, the profile module 112 updates the profile in the user profile storage 120 according to the user's request. If a user request to post on another user's profile, the profile module 112 determines from the identity module 110 the user's current identity. The profile module 112 updates the profile in the storage 120 according to the request and indicates that the post is by the current identity of the user. For example, if a user is interacting with the system 104 as a non-user page and requests to post a message on another user's profile, the profile module 112 will post the message to the profile and indicate that the post was by the non-user page.

In one embodiment, the profile module 112 monitors for certain social interactions, such as users accepting friend requests and postings on profiles of friends. If a user is involved in a social interaction monitored for, the profile module 112 updates the user's profile in the user profile storage 120. The profile is updated to indicate that the user was involved in the social interaction. For example, if the user accepted another user's friend request, the user's profile may be updated to describe that the user is now friends with the other user.

The page module 114 manages the creation, access, and update of non-user pages. In one embodiment, when a user requests to create a non-user page to represent an entity in the system 104, the page module 114 creates the page in the non-user page storage 122 and populates the page with information provided by the user (e.g., basic information about the entity and pictures). The page module 114 stores with the page an indication that the user is an administrator of the page. At the request of the administrator, the page module 114 can add other users as administrators.

When a user requests access to a non-user page, the page module 114 determines from the identity module 110 the current identity of the user in the system 104. Based on the identity of the user, the page module 114 determines the information of the non-user page accessible to the requesting user. In one embodiment, the profile information accessible to the user depends on the connections between the identity of the user and the non-user page. The page module 114 retrieves from the non-user page storage 122 and transmits to the user device 102, information from the non-user page determined by the module 114 to be accessible by the current identity of the requesting user. The transmitted information is displayed to the user.

The page module 114 updates the non-user pages stored in the non-user page storage 122 based on social interactions in the system 104. When a user requests to post on a page, the page module 114 determines from the identity module 110 the user's current identity. The page module 114 updates the page in the storage 122 according to the request and indicates that the post is by the current identity of the user. If an administrator of a page requests to update the information of the page (e.g., the basic information of the entity the page represents), the page module 114 updates the page in the storage 122 according to the request.

The recommendation module 115 determines non-user pages to recommend to users. In one embodiment, when a user performs certain social interactions, such as accessing a non-user page, the recommendation module 115 determines pages to recommend to the user. The pages are recommended as pages that the user should establish a connection with. To determine the pages to recommend to the user, the recommendation module 115 determines from the identity module 110 the current identity of the user. The recommendation module 115 identifies pages indirectly connected to the identity through other users or pages. For example, assume the identity of the user is of himself. A page that shares a connection with one of the user's friends is indirectly connected to the user since the user and the friend are connected.

From the identified pages, the recommendation module 115 removes any pages with which the identity already has a direct connection. The recommendation module 115 ranks the remaining pages. In one embodiment, the recommendation module 115 ranks the pages based on how closely connected the pages are with the identity. In one embodiment, the more connections that a page shares with the identity, the higher the ranking of the page. For example, assume that the user is interacting in system 104 as himself. If a page is directly connected to ten of the user's friends, that page will get a higher ranking than a page with which only one of the user's friends is connected. The recommendation module 115 selects a certain number of the pages based on their ranking. For example, the recommendation module 115 may select the five highest ranked pages. The recommendation transmits to the user device 102 a recommendation that the user connect with one of the selected pages.

If the user requests to connect with a recommended page and the user is interacting with the system 104 as a page, the connection is established between the page the user is interacting as and the recommended page. On the other hand, if the user selects to connect with a recommended page and the user is interacting with the system 104 as himself, the connection is established between the user and the recommended page.

The feed module 116 provides news feeds to users. A news feed is a list of social interactions in the social networking system 104. In one embodiment, the feed module 116 tracks social interactions in the system 104 by users and pages. The social interactions tracked may include, for example, posts, tags, acceptance of friend requests, changes in profile information, and joining a group.

A news feed presented to a user is personalized according to the current identity of the user. In one embodiment, when a user requests a news feed, the feed module 116 determines from the identity module 110 the current identity of the user. The feed module 116 identifies from the social interactions tracked, interactions by users and pages that are connected with the current identity of the user. In one embodiment, the social interactions identified are interactions that have occurred within a certain time period, such as within the last 2 hours or since the last time a newsfeed was requested for the identity of the user.

The feed module 116 transmits the identified social interactions to the client device 102 for display as the news feed. In one embodiment, the social interactions of the newsfeed are displayed in chronological order.

### Process

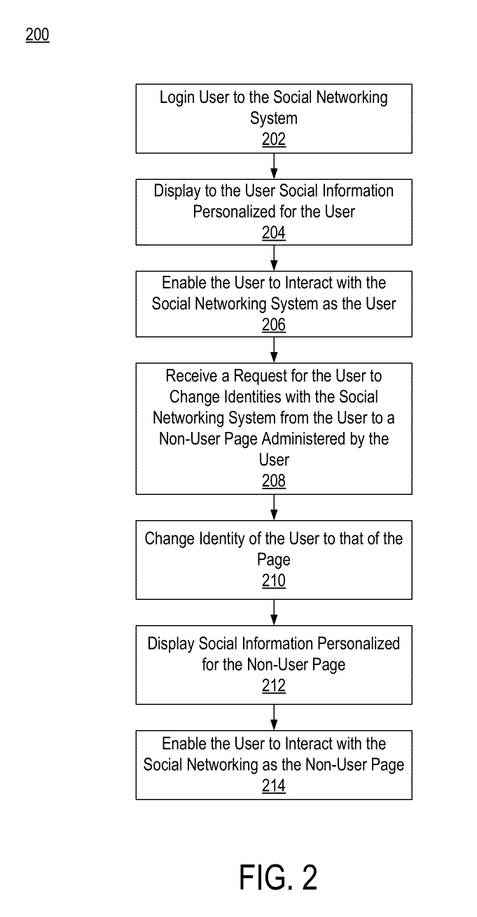

FIG. 2 is a flow diagram 200 of a process performed by the social networking system 104 for changing the identity of a user in the system 104 according to one embodiment. Assume for purposes of this example that the user has requested to login to the system 104 through the user device 102, the user has provided authentication information, and that the authentication information has been verified. The social networking system 104 logs 202 the user into the system 104. The current identity of the user with the system 104 is of himself. As a result, the social networking system 104 displays 204 to the user social information personalized for the user. What is meant herein by the system 104 “displaying” is that the system 104 transmits information to the user device 102 for the device 102 to generate a display for the user. The system 104 enables the user to interact 206 with the system as himself.

When the system 104 receives 208 a request from the user device 102 for the user to change identities in the system 104 from the user to a non-user page administered by the user, the system 104 changes 210 the identity of the user with the system 104 to that of the page without the user having to provide additional authentication information. The system 104 displays 212 to the user social information personalized for the page. The system 104 enables 214 the user to interact with the system 104 as the page.

### EXAMPLE

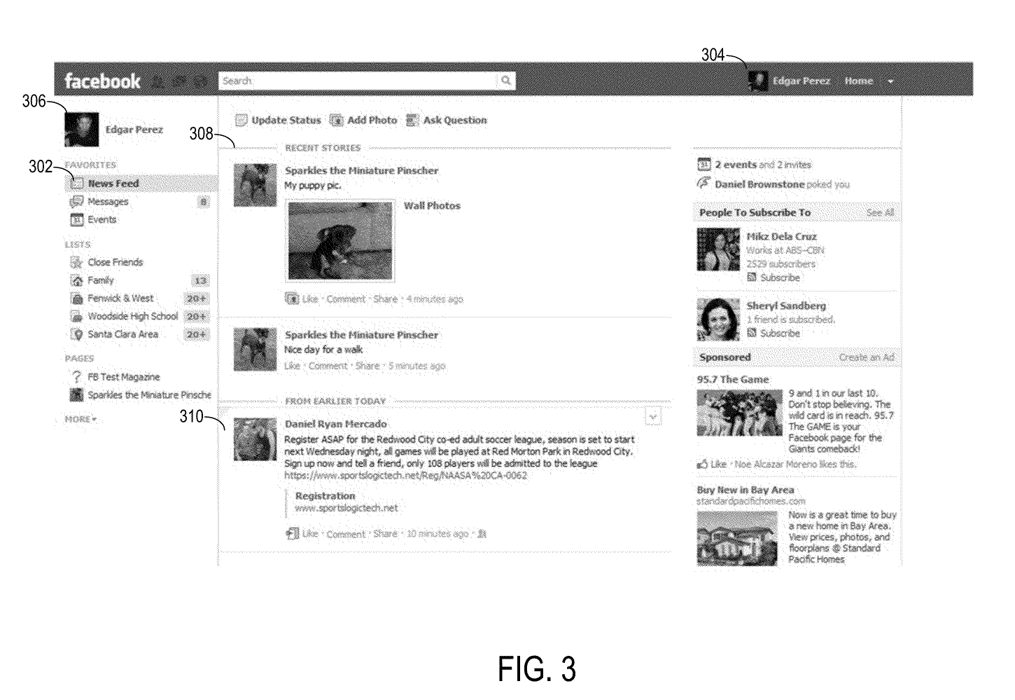

FIGS. 3-11 illustrate an example of a user changing identities in the social networking system 104 according one embodiment. Assume for purposes of this example that user is “Edgar Perez” and the user is currently interacting with the system 104 under that identity.

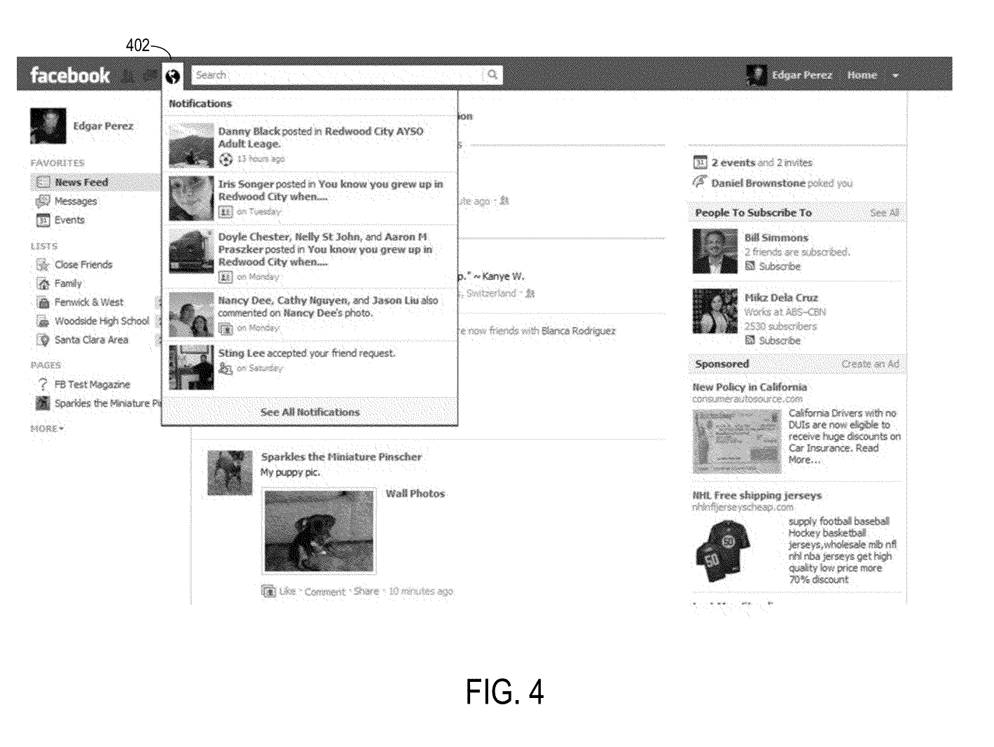

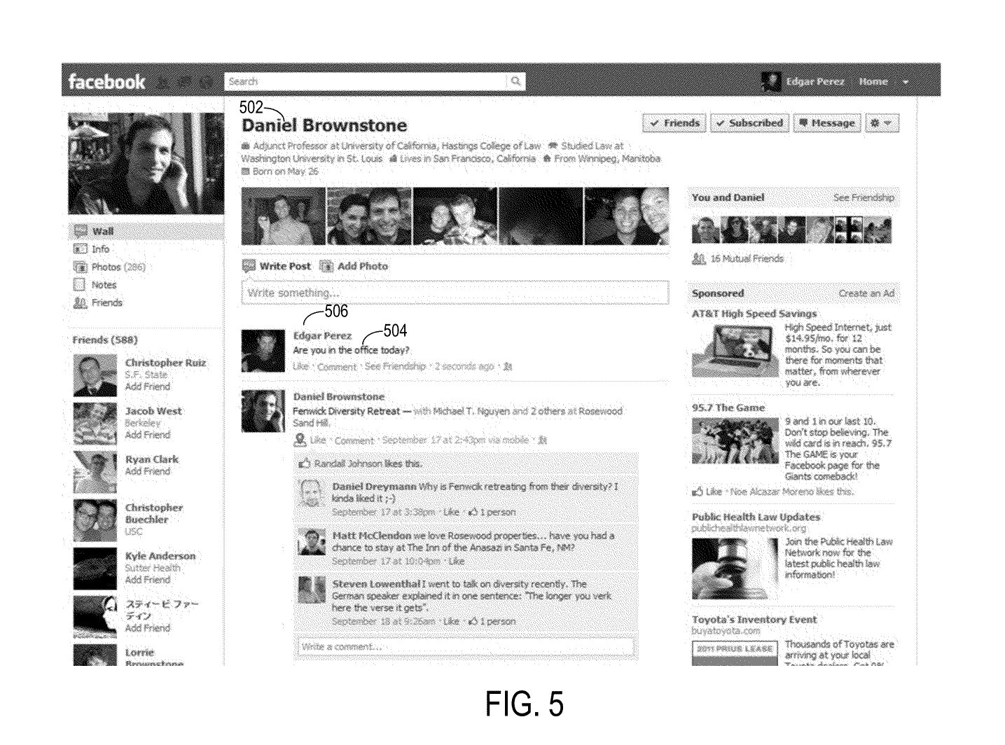

FIG. 3 illustrates a news feed 302 displayed to the user. Icons 304 and 306 show that the user is currently interacting with the system 104 as himself. Since the user is interacting as himself, the social information displayed to the user is personalized for the user. This is demonstrated in FIG. 3 in that the social interactions in the news feed 302 are of users and pages that are connected to the user in system 104. Section 308 of the news feed includes the most recent social interactions and section 310 includes older interactions. FIG. 4 illustrates that the notifications 402 (i.e., personal information) accessible to the user are his own notifications. FIG. 5 illustrates that if the user interacts in the system 104 by posting a comment 504 on another user's profile 502, an indicator 506 is included with post indicating that the post was by the user.

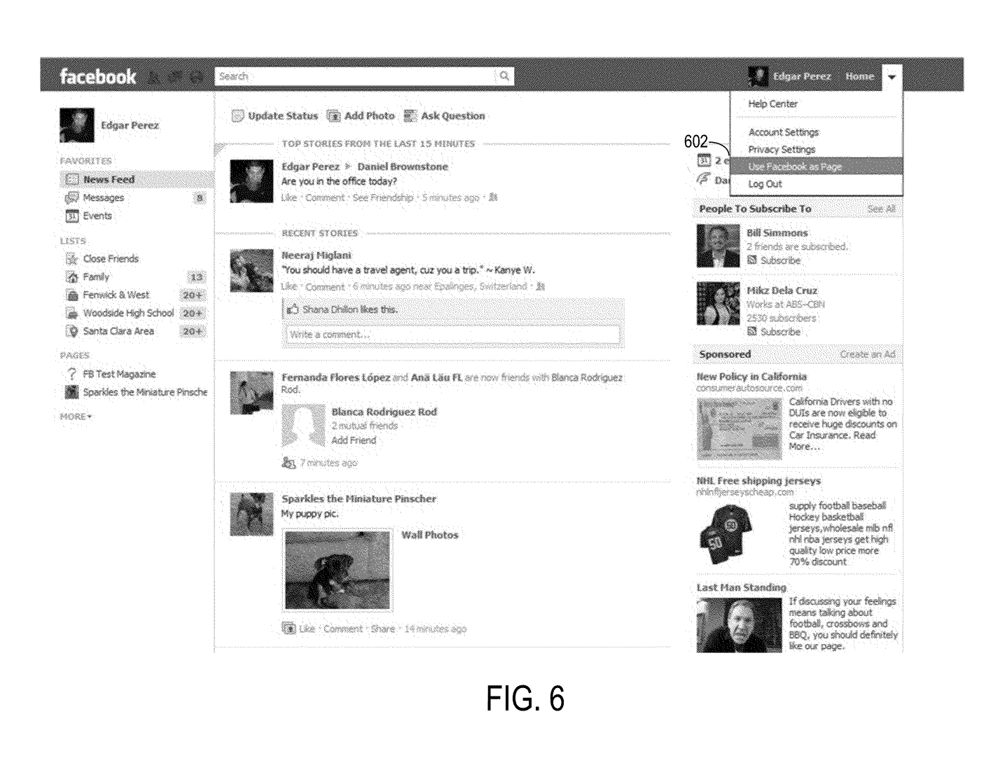

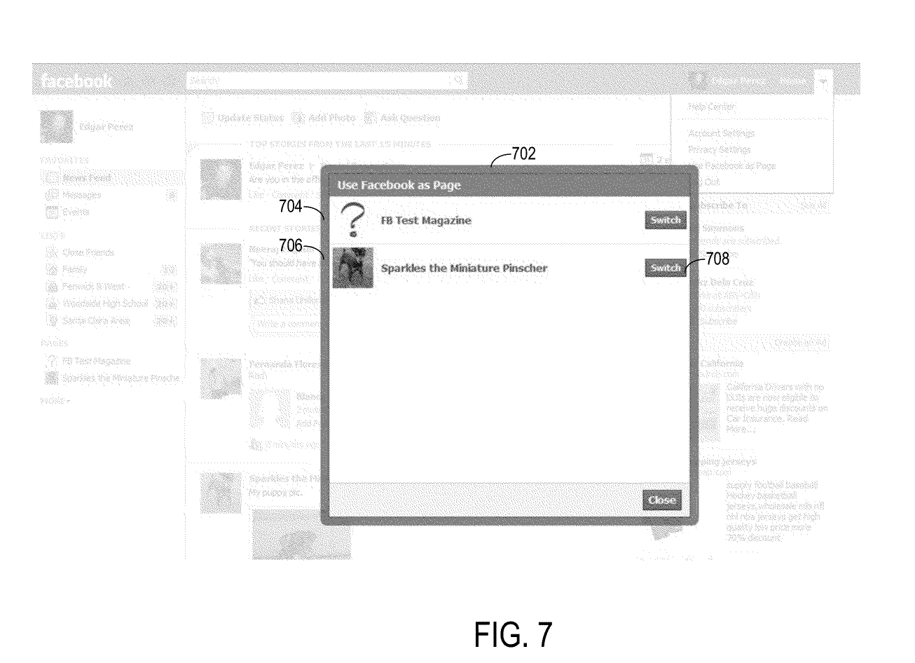

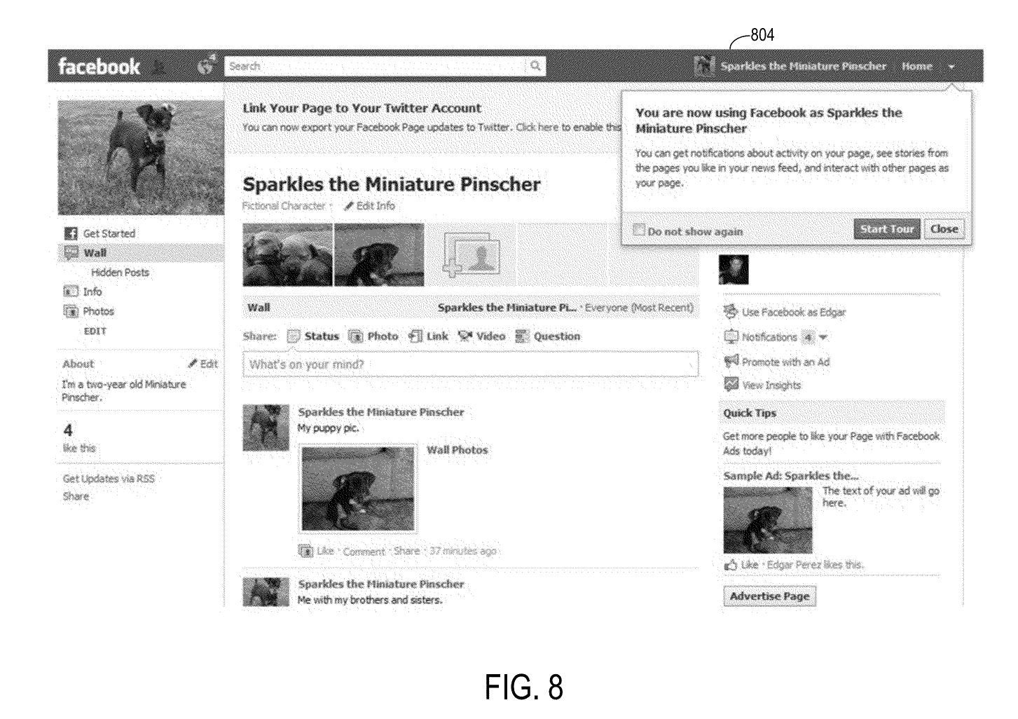

To change identities and undertake the identity of a non-user page with the system 104, the user selects a “Use as Page” button 602 as shown in FIG. 6. FIG. 7 illustrates that when the button 602 is selected, a pop-up window 702 is displayed. The window 702 includes the non-user pages of which the user is an administrator. In this example, the user is the administrator of two pages, page 704 and page 706. If the user selects button 708, the user undertakes the identity of page 706, which is a page that represents a Miniature Pinscher by the name of Sparkles. Icon 804 of FIG. 8 illustrates that the user is now interacting with the system 104 as the page 706. As can be seen, the user did not have to provide authentication information (e.g., a password) to switch identities.

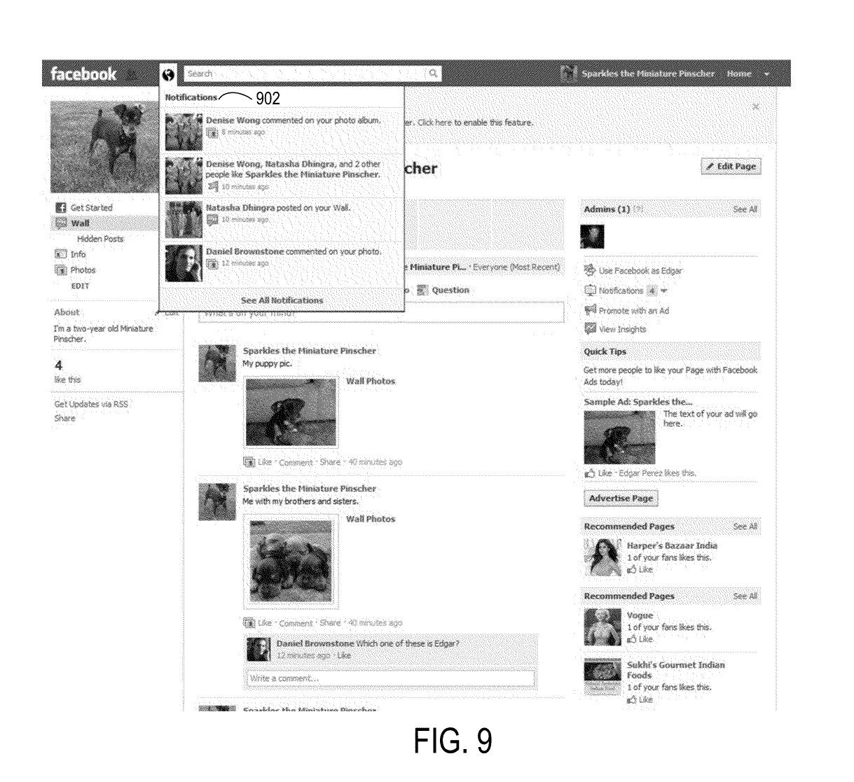

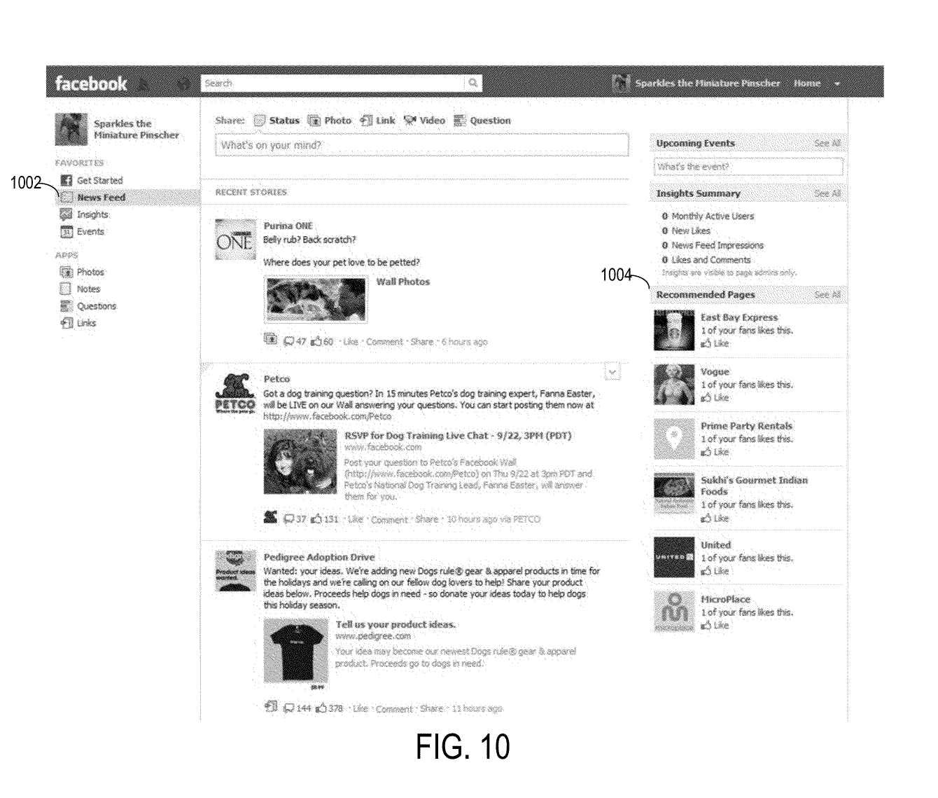

FIGS. 9 and 10 show that since the user has undertaken the identity of the page 706, the social information displayed to the user is personalized for the page 706. In FIG. 9, the notifications 902 displayed to the user are those of the page 706. FIG. 10 shows that the news feed 1002 displayed to the user includes social interactions of pages connected with the page 706. Additionally, FIG. 10 shows non-user pages 1004 recommended to the user. The pages 1004 are recommended as pages with which the page 706 may be interested of establishing a connection with.

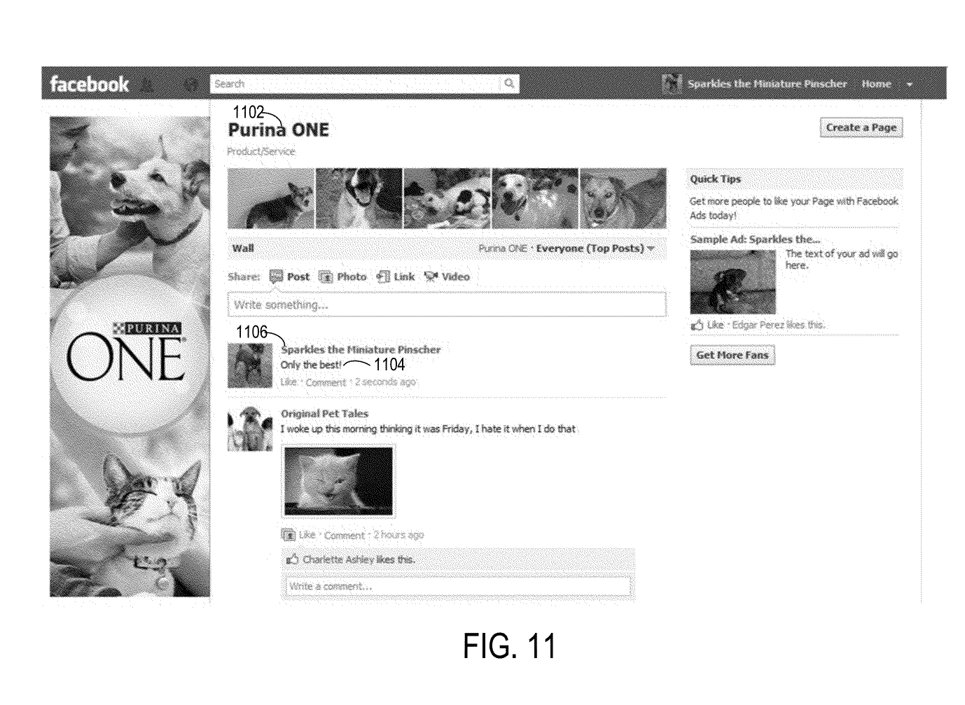

FIG. 11 illustrates a comment 1104 posted by the user on another non-user page 1102. An indicator 1106 is included with the post indicating that the comment 1104 was posted by the page 706. Thus, based on the current identity of the user as the page 706, any social interactions in the system 104 are performed as if they were done by the page 706.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A computer-implemented method comprising:
displaying to a user of a social networking system social information personalized for the user, the social networking system including a plurality of users and a plurality of non-user pages, each of the plurality of non-user pages administered by at least one of the plurality of users;
responsive to receiving a request for the user to change identities with the social networking system from the user to a non-user page administered by the user, displaying to the user social information personalized for the non-user page;
receiving from the user a request to perform a social interaction in the social networking system; and
performing the social interaction in the social networking system as the non-user page.

2. The method of claim 1, wherein the social information personalized for the user is displayed responsive to the user logging into the social networking system.

3. The method of claim 1, wherein displaying to the user social information personalized for the non-user page comprises:
receiving a request for social information;
determining that a current identity of the user with the social networking system is of the non-user page;
determining social information accessible by the non-user page; and
displaying to the user the social information determined to be accessible by the non-user page.

4. The method of claim 1, wherein the social information personalized for the non-user page includes private information unique to the non-user page and shared with an administrator of the page.

5. The method of claim 1, wherein the social information personalized for the non-user page includes information from a user profile accessible by the non-user page.

6. The method of claim 1, wherein the social information personalized for the non-user page includes page information accessible by the non-user page.

7. The method of claim 1, wherein the social information personalized for the non-user page includes a news feed with social interactions by users and additional non-user pages connected to the non-user page.

8. The method of claim 1, wherein the social interaction is a post and performing the social interaction in the social networking system as the non-user page comprises indicating that the post was by the non-user page.

9. The method of claim 1, further comprising:
responsive to receiving the request for the user to change identities with the social networking system from the user to the non-user page, changing an identity of the user with the system to an identity of the non-user page; and
displaying to the user recommended non-user pages for the non-user page to establish a connection with one or more of the recommended pages.

10. The method of claim 9, wherein displaying to the user recommended non-user pages comprises:
identifying additional non-user pages indirectly connected to the non-user page;
selecting from the identified additional pages one or more additional pages to recommend;
transmitting the one or more selected additional pages to a user device for display to the user as recommended non-user pages.

11. The method of claim 10, wherein selecting one or more page comprises:
ranking the identified additional pages, wherein each additional page is ranked based on a number of connections the additional page shares with the non-user page; and
selecting a number of the additional pages based on their ranking.

12. A non-transitory computer readable storage medium having computer program instructions, the computer program instructions to configure a processor to perform operations comprising:
displaying to a user of a social networking system social information personalized for the user, the social networking system including a plurality of users and a plurality of non-user pages, each of the plurality of non-user pages administered by at least one of the plurality of users;
responsive to receiving a request for the user to change identities with the social networking system from the user to a non-user page administered by the user, displaying to the user social information personalized for the non-user page;
receiving from the user a request to perform a social interaction in the social networking system; and
performing the social interaction in the social networking system as the non-user page.

13. The non-transitory computer readable storage medium of claim 12, wherein the social information personalized for the user is displayed responsive to the user logging into the social networking system.

14. The non-transitory computer readable storage medium of claim 12, wherein displaying to the user social information personalized for the non-user page comprises:
receiving a request for social information;
determining that a current identity of the user with the social networking system is of the non-user page;
determining social information accessible by the non-user page; and
displaying to the user the social information determined to be accessible by the non-user page.

15. The non-transitory computer readable storage medium of claim 12, wherein the social information personalized for the non-user page includes private information unique to the non-user page and shared with an administrator of the page.

16. The non-transitory computer readable storage medium of claim 12, wherein the social information personalized for the non-user page includes information from a user profile accessible by the non-user page.

17. The non-transitory computer readable storage medium of claim 12, wherein the social information personalized for the non-user page includes page information accessible by the non-user page.

18. The non-transitory computer readable storage medium of claim 12, wherein the social information personalized for the non-user page includes a news feed with social interactions by users and additional non-user pages connected to the non-user page.

19. The non-transitory computer readable storage medium of claim 12, wherein the social interaction is a post and performing the social interaction in the social networking system as the non-user page comprises indicating that the post was by the non-user page.

20. The non-transitory computer readable storage medium of claim 12, further comprising:
responsive to receiving the request for the user to change identities with the social networking system from the user to the non-user page, changing an identity of the user with the system to an identity of the non-user page; and
displaying to the user recommended non-user pages for the non-user page to establish a connection with one or more of the recommended pages.
